(19) United States
(12) Patent Application Publication
(10) Pub. No.: US 2025/0029155 A1
(43) Pub. Date: Jan. 23, 2025

(54) DETERMINATION DEVICE, DETERMINATION METHOD, AND RECORDING MEDIUM

(71) Applicant: NEC Corporation, Minato-ku, Tokyo (JP)

(72) Inventors: Kazuma SHIMIZU, Tokyo (JP); Shinji ITO, Tokyo (JP); Shinji NAKADAI, Tokyo (JP)

(73) Assignee: NEC Corporation, Minato-ku, Tokyo (JP)

(21) Appl. No.: 18/713,772

(22) PCT Filed: Dec. 2, 2021
(86) PCT No.: PCT/JP2021/044259

§ 371 Date: May 28, 2024

(51) Int. Cl. G06Q 30/0283; G06Q 10/02; G06Q 50/40

(52) U.S. Cl. CPC G06Q 30/0283; G06Q 10/02; G06Q 50/40

(57) ABSTRACT

Based on a relation model representing a relationship between first data and second data, second data in an evaluation period is calculated from first data in the evaluation period. An evaluation value pertaining to the evaluation period is calculated by using an evaluation model and the calculated second data in the evaluation period, the evaluation model including the second data as a parameter. First data in the evaluation period in a case in which the calculated evaluation value increases are determined.

### TECHNICAL FIELD

This invention relates to a determination device or the like that can increase various efficiencies, such as control efficiency and cost performance.

### BACKGROUND ART

The technology of a system that predicts demand based on time trends in the number of service reservations and a system that determines prices based on that demand prediction is disclosed in Patent Document 1. Also, the technology of a method for predicting demand based on the price of timed inventory is disclosed in Patent Document 2.

### PRIOR ART DOCUMENTS

### Patent Documents

Patent Document 1: Japanese Unexamined Patent Application, First Publication No. 2021-33718
Patent Document 2: Published Japanese Translation No. 2018-503172 of the PCT International Publication

### SUMMARY OF THE INVENTION

### Problems to be Solved by the Invention

However, even in a case where using the techniques described in the cited reference 1 and the techniques described in the cited reference 2, it is difficult to determine a price that will, for example, increase a valuation index such as reward over a certain period of time. The reason for this is that these techniques have not been evaluated for a given time period.

Therefore, one of the purposes of the present invention is to provide a determination device, seat reservation device, transaction control device, advertisement control device, navigation device, control device, determination method, recording medium, etc. that can increase control efficiency, cost performance, and other efficiencies.

### Means for Solving the Problem

According to the first example aspect of the present invention, a determination device includes: a calculation means that, based on a relation model representing a relationship between first data and second data, calculates second data in an evaluation period from first data in the evaluation period: an evaluation means that calculates an evaluation value pertaining to the evaluation period by using an evaluation model and the calculated second data in the evaluation period, the evaluation model including the second data as a parameter; and a determination means that determines first data in the evaluation period in a case in which the calculated evaluation value increases.

According to the second example aspect of the present invention, in a determination method, a computer executes: based on a relation model representing a relationship between first data and second data, calculating second data in an evaluation period from first data in the evaluation period; calculating an evaluation value pertaining to the evaluation period by using an evaluation model and the calculated second data in the evaluation period, the evaluation model including the second data as a parameter; and determining first data in the evaluation period in a case in which the calculated evaluation value increases.

According to the third example aspect of the present invention, a recording medium stores a program that causes a computer to realize function of: based on a relation model representing a relationship between first data and second data, calculating second data in an evaluation period from first data in the evaluation period: calculating an evaluation value pertaining to the evaluation period by using an evaluation model and the calculated second data in the evaluation period, the evaluation model including the second data as a parameter; and determining first data in the evaluation period in a case in which the calculated evaluation value increases.

### Effects of Invention

According to the determination device, etc., of the present invention, it is possible to increase the efficiency of control and cost performance.

### BRIEF DESCRIPTION OF THE DRAWINGS

FIG. 1 is a block diagram showing the configuration of the determination device according to the first example embodiment.

FIG. 2 is a flowchart showing the process flow in the determination device according to the first example embodiment.

FIG. 3 is a flowchart showing the process flow in the determination device according to the first example embodiment.

FIG. 4 is a block diagram showing the configuration of the seat reservation device according to the second example embodiment.

FIG. 5 is a diagram that conceptually illustrates an example of applying the determination device to aircraft seat reservations.

FIG. 6 is a block diagram showing the configuration of the transaction control device according to the third example embodiment.

FIG. 7 is a block diagram showing the configuration of the advertisement control device according to the fourth example embodiment.

FIG. 8 is a block diagram showing the configuration of the navigation device according to the fifth example embodiment.

FIG. 9 is a block diagram showing the configuration of the control device according to the sixth example embodiment.

FIG. 10 is a block diagram schematically showing an example hardware configuration of a computing processor that can realize a determination device, a control device, a seat reservation device, a transaction control device, an advertisement control device, and a navigation device for each example embodiment.

### EXAMPLE EMBODIMENT

Next, an example embodiment of the present invention will be described in detail with reference to the drawings.

### First Example Embodiment

With reference to FIG. 1, the configuration of a determination device 1 of the first example embodiment of the present invention will be described in detail. FIG. 1 is a block diagram showing the configuration of the determination device 1 according to the first example embodiment. The determination device 1 according to the first example embodiment has a calculation portion 11, an evaluation portion 12, and a determination portion 13. The determination device 1 may further have a creation portion 14 and an update portion 15.

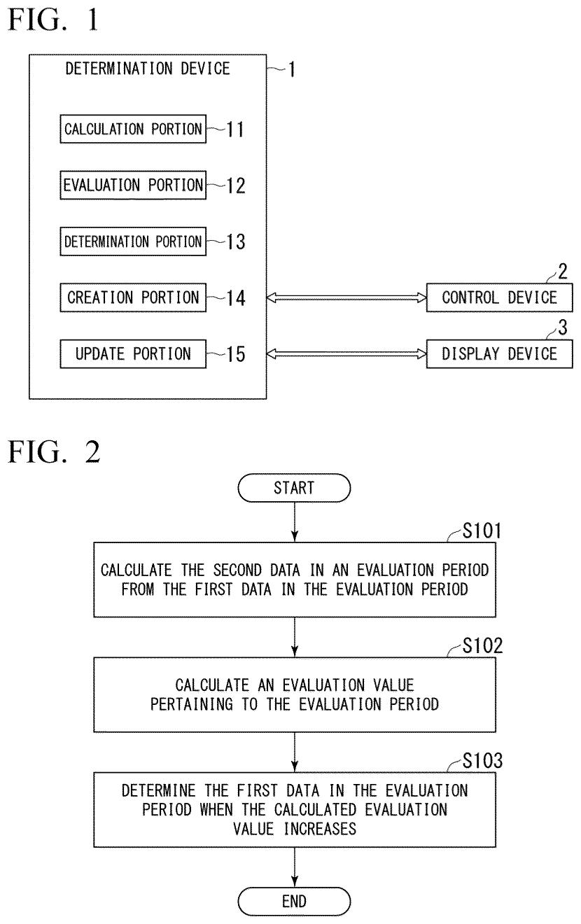

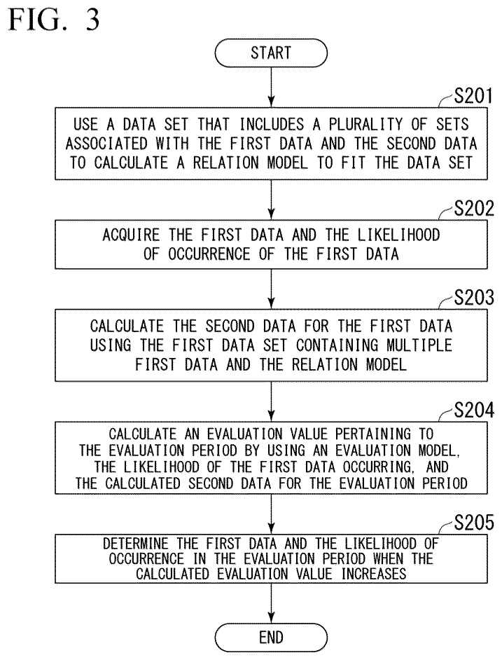

The determination device 1 may be connected to, for example, a control device 2 or a display device 3. Alternatively, the determination device 1 may have components that realize the functions that the control device 2 has or the display device 3 has. The determination device 1 determines the data that can increase efficiency, such as control efficiency and cost performance, by using a relation model representing the relationship between the first data and the second data, and by executing the process as detailed in FIGS. 2 and 3.

As shown in the example in the second example embodiment, the first data represents the price for reserving a seat on an airplane. The second data represents the quantity demanded with respect to the reservation at that price. Alternatively, as shown in the example in the third example embodiment, the first data may represent a business partner with which the merchandise is transacted. The second data may represent the demand amount from the business partner. Alternatively, as shown in the example in the fourth example embodiment, the first data may represent, for example, an advertisement to be displayed over a communication network. The second data may represent the percentage of views of the advertisement (or the click-through rate). Alternatively, as shown in the example in the fifth example embodiment, the first data may represent a route for transporting merchandise. The second data may represent the time required (or travel time, etc.) for transportation along the route. Alternatively, as shown in the example in the sixth example embodiment, the first data may represent a generator when acquiring motive power using a generator. The second data may represent the electrical power consumption when acquiring motive power using the generator.

Thus, the first data is associated with the second data, and the relationship between them is represented using a relation model. The relation model represents the relationship between the first data and the second data. The relation model is realized, for example, by regression analysis, machine learning (e.g., neural networks, support vector machines), and the like. The relation model may also have multiple parameters determined by regression analysis and be represented by an ensemble of these parameters.

The relation model is, for example, a demand model that represents the relationship between price and quantity demanded, as shown in the example in the second example embodiment. Alternatively, the relation model may be, for example, a demand model that represents the relationship between a business partner and the demand amount by that business partner, as shown in the example in the third example embodiment. Alternatively, the relation model may be a rate model representing the relationship between the advertisement and the rate at which the advertisement is viewed, for example, as shown in the example in the fourth example embodiment. Alternatively, the relation model may be, for example, a travel time model representing the relationship between the route and the time required on that route, as shown in the example in the fifth example embodiment. Alternatively, the relation model may be, for example, a power model representing the relationship between the generator and the electrical power consumed by the generator, as shown in the example in the sixth example embodiment.

Next, with reference to FIG. 2, a detailed description of the process in the determination device 1 of the first example embodiment of the present invention will be given. FIG. 2 is a flowchart showing the process flow in the determination device 1 according to the first example embodiment.

The calculation portion 11, on the basis of a relation model representing the relationship between first data and second data as described above, calculates the second data in an evaluation period from the first data in the evaluation period (Step S101). The calculation portion 11, for example, calculates the second data in the evaluation period by applying a process expressing the relationship to the first data in the evaluation period.

The evaluation portion 12 calculates an evaluation value pertaining to the evaluation period using an evaluation model including the second data as a parameter and the calculated second data in the evaluation period (Step S102). The evaluation portion 12, for example, calculates an evaluation value pertaining to the evaluation period by applying the process indicated by the evaluation model to the calculated second data in the evaluation period.

The evaluation model represents, for example, a process for calculating an evaluation value representing the degree of desirability (or favorability), as described below in the second and sixth example embodiments. As illustrated in the second example embodiment, the evaluation model represents, for example, the profit (compensation, revenue) in the evaluation period. Alternatively, as illustrated in the third example embodiment, the evaluation model represents, for example, the amount of demand in the evaluation period.

The determination portion 13 determines the first data in the evaluation period in a case in which the calculated evaluation value increases (Step S103). The determination portion 13 determines the first data so that the value calculated according to the evaluation model (e.g., objective function) increases, as illustrated in the second example embodiment. This process can be realized, for example, by a method of finding a solution to an optimization problem with constraints, or by a method of sequentially searching for the first data in a case in which the objective function is increasing. The determination portion 13 may determine the first data in the evaluation period in a case in which the constraint condition including the second data in the evaluation period as a parameter is satisfied and the evaluation value increases.

The constraint condition is, for example, that the number of reservations in the evaluation period is less than or equal to the remaining amount, as shown in the example in the second example embodiment. Alternatively, the constraint condition may be, for example, that the amount of demand for merchandise during the evaluation period is less than or equal to the amount of inventory of the merchandise, as shown in the example in the third example embodiment. Alternatively, the constraint condition may be, for example, that the time of displaying an advertisement in the evaluation period is less than or equal to the reference value, as shown in the example in the fourth example embodiment. Alternatively, the constraint condition may be, for example, that the time required to move during the evaluation period is less than or equal to a reference value, as shown in the example in the fifth example embodiment. Alternatively, the constraint condition may be, for example, that the total electrical power consumption of the generator during the evaluation period is equal to or less than the reference value, as shown in the example in the sixth example embodiment.

The control device 2 receives the first data and performs control according to the received first data. The control device 2, for example, controls a system that controls multiple generators and other control targets, as shown in the example in the sixth example embodiment. The control device 2 performs control, for example, to obtain motive power from the generator represented by the first data received. The control object may be, for example, a robot, manufacturing machine, automated guided vehicle, truck, construction heavy equipment, or other device.

The display device 3 may show the determined first data on a display. The display device 3 is, for example, a seat reservation system as shown in the example in the second example embodiment. In this case, the display device 3 shows the determined first data on the display of the seat reservation system. The display device 3 may be a system that displays advertisements, for example, as shown in the example in the fourth example embodiment. The display device 3 shows the determined first data, for example, on the right side of the browser.

In the processing example described above with reference to FIG. 2, the determination device 1 calculates the evaluation value pertaining to the evaluation period using the relation model. The determination device 1 may further create a relation model. The process of creating a relation model is described below.

The creation portion 14 inputs a data set that is associated with the first data and the second data. The creation portion 14 creates the aforementioned relation model that fits the data set. The creation portion 14 creates a relation model representing the relationship between the first data and the second data by applying processing such as regression analysis, machine learning (e.g., neural networks, support vector machines), and the like to the input data set. The calculation portion 11 then uses the relation model created by the creation portion 14 to perform the processing described above with reference to FIG. 2.

The update portion 15 may create a relation model representing the relationship between the first data and the second data by acquiring the second data for the first data determined by the determination portion 13 and performing the same process as the creation portion 14 on the first data and the acquired second data. The calculation portion 11 performs the processing described above with reference to FIG. 2, using the relation model created by the update portion 15. Therefore, it can be said that the update portion 15 acquires the second data for the first data determined by the determination portion 13 and executes the process of updating the relation model using the acquired second data.

The relationship between the first data and the second data may be, for example, a relationship about the first period. In this case, the first period includes the timing before each timing in the evaluation period. In the processing example described above with reference to FIG. 2, the determination device 1 calculates an evaluation value pertaining to the evaluation period by using the relation model.

Referring to FIG. 3, a description will be given for the process in which the relation model creates a relationship between the first data and the second data based on the distribution of the second data (or probability distribution of the second data). FIG. 3 is a flowchart showing the process flow in the determination device 1 according to the first example embodiment.

The calculation portion 11 uses a data set that includes a plurality of sets associated with the first data and the second data to calculate a relation model to fit the data set (Step S201). In this case, the calculation portion 11 calculates the relation model based on the distribution (or probability distribution) of the second data.

The data set is, for example, a data set that associates a price with the quantity demanded at that price, as described below in the second example embodiment. The data set may include a set for each timing in the first period. Alternatively, if a period between the start timing and end timing occurs for each aircraft, as in the example of reserving a seat in an aircraft as described below in the second example embodiment, the data set may be created by aligning the lengths of the multiple periods. In this case, the data set includes a set of first data (e.g., price) and second data (e.g., quantity demanded) associated with each timing in the period.

The evaluation portion 12 acquires the first data and the likelihood of occurrence of the first data (Step S202). This likelihood of occurrence is determined in steps S202 through S205 so that the evaluation value increases. The likelihood of occurrence may represent a probability or may be a value calculated from the probability. The evaluation portion 12 may determine a plurality of first data and the likelihood of occurrence of each first data. The first data may be selected from the first data set. The first data set may be a given data set or a data set extracted from a relation model.

The evaluation portion 12 calculates the second data for the first data using the first data set containing multiple first data and the relation model (Step S203).

Next, the evaluation portion 12 calculates an evaluation value pertaining to the evaluation period by using an evaluation model that includes the second data as a parameter, the likelihood of the first data occurring, and the calculated second data for the evaluation period (Step S204). The evaluation model is the same as the model described above and represents the process of calculating evaluation values that represent the degree of desirability (or desirability). The evaluation model represents, for example, the process as described below with reference to Expression (3).

The determination portion 13 determines the first data and the likelihood of occurrence in the evaluation period in a case in which the calculated evaluation value increases (Step S205).

The determination portion 13 may output the determined first data to an external device such as the control device 2 or the display device 3. The relation model may be created by the creation portion 14 or updated by the update portion 15. The relation model may be, for example, the second data for the first data, for the first period. In this case, the first period includes the timing before each timing in the evaluation period.

Next, the effects related to the determination device 1 of the first example embodiment of the invention will be described.

According to the determination device 1 of the first example embodiment, the control efficiency, cost performance, etc. can be increased. The reason for this is that the evaluation value is calculated using an evaluation model that includes the second data as a parameter to determine the first data in the case of an increase in the evaluation value.

For example, the techniques disclosed in Patent Documents 1 and 2, for example, predict demand but cannot evaluate evaluation models that include that demand as a parameter. However, in the determination device 1 according to the first example embodiment, the evaluation model including the second data as a parameter is used to determine the first data in a case in which the evaluation value increases, in accordance with the process described above with reference to FIGS. 2 and 3. Therefore, according to the determination device 1 of the first example embodiment, efficiency such as control efficiency and cost performance can be increased.

### Second Example Embodiment

Next, the second example embodiment of the present invention, which is based on the first example embodiment described above, shall be described.

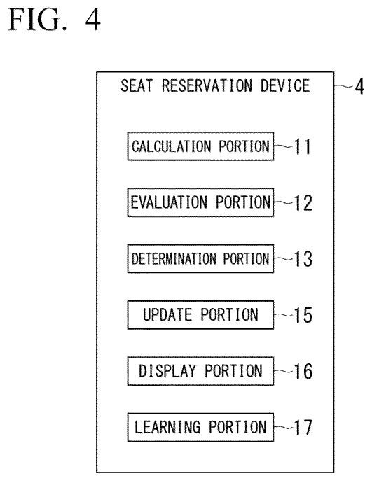

With reference to FIG. 4, the processing in the determination device 1 according to the first example embodiment will be explained using the example of applying it to the reservation of a seat in an aircraft (hereinafter referred to as “seat reservation”). FIG. 4 is a block diagram showing the configuration of a seat reservation device 4 according to the second example embodiment of the present invention. The seat reservation device 4 according to the second example embodiment has a calculation portion 11, an evaluation portion 12, a determination portion 13, and a display portion 16. The seat reservation device 4 may have a learning portion 17 and an update portion 15.

The calculation portion 11 has the same functions as those possessed by the calculation portion 11 as described above with reference to FIG. 1. The evaluation portion 12 has the same functions as those possessed by the evaluation portion 12 as described above with reference to FIG. 1. The determination portion 13 has the same functions as those possessed by the determination portion 13 as described above with reference to FIG. 1. The display portion 16 has the same functions as those possessed by the display device 3 as described above with reference to FIG. 1. The learning portion 17 has the same functions as those possessed by the learning portion 17 as described above with reference to FIG. 1. The update portion 15 has the same functions as the update portion 15 has as described above with reference to FIG. 1. Therefore, the seat reservation device 4 has functions similar to those possessed by determination device 1 as described above with reference to FIG. 1.

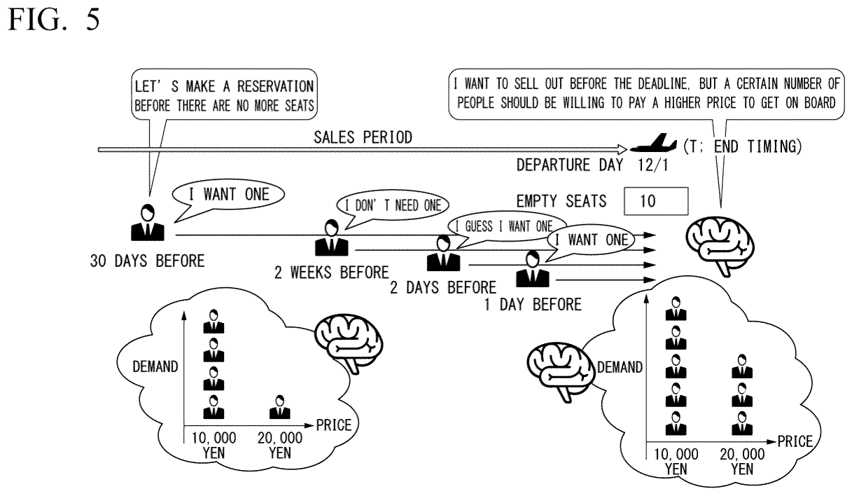

Next, with reference to FIG. 5, the processing in the seat reservation device 4 according to the second example embodiment of the present invention will be described in detail. FIG. 5 is a diagram that conceptually illustrates an example of applying the determination device 1 to aircraft seat reservations.

Aircraft seat reservations can be made in a period from the timing when the reservation is started (hereinafter referred to as “start timing”) to the time when the reservation is ended (hereinafter referred to as “end timing T”). The end timing T is, for example, the timing when the number of reservations equals the number of seats, or the timing just before the aircraft takes off. In the following description, for the sake of explanation, the end timing T is assumed to be the timing just before the aircraft takes off. The period from the start timing to the end timing is denoted as the “sales period”.

The price of a seat reservation, for example, varies depending on the type of seat and the length of the period from the timing at which the reservation is made (hereinafter referred to as “timing t”) to the end timing T (hereinafter referred to as “remaining period”). For the purposes of the following discussion, prices are assumed to be set lower in a case where the remaining period is 30 days or more than in a case where the remaining period is less than 30 days. The period from the start timing to the timing 30 days prior to takeoff is represented as the “discount period”. The period from the timing 29 days before takeoff to the end timing T is denoted as the “normal period”. The price during the discount period is denoted as the “discounted price”. The price in the normal period is denoted as the “normal price”. The difference between the number of seats on the aircraft and the number of seats already reserved is denoted as “remaining capacity”. For convenience, the remaining amount at timing t is denoted as n (t).

Demand in the discount period is assumed to be greater than demand in the normal period. This represents a large number of requests to reserve seats at a lower price before seat reservations are completed. Even in the normal period, the amount of demand is assumed to be higher near the end timing T (e.g., two days or one day before the end timing T) than in other periods in the normal period. In this case, the total amount of sales (hereafter denoted as “gross sales”) may increase if the price is set according to the increase or decrease in the quantity demanded, rather than if the price is set at two levels, a discounted price and a normal price. Therefore, in order to increase gross sales (or maximize gross sales), for example, prices must be set appropriately in light of changes in the quantity demanded. In the following examples of aircraft seat reservations, the term gross sales will be used, but profit, compensation, or other terms may also be used.

The demand amount D (t, p(t)), for example, is related to timing t and the price p(t) at the timing t. In other words, timing t, price p(t), and demand amount have a relationship. The demand amount in a case where the price is price p(t) at timing t is denoted as “D(t, p(t))”. The model representing the relationship is denoted as “demand model λ”. Thus, in this case, the demand amount λ(t, p) is calculated by the process of applying the demand model λ to the timing t and the price p(t). The price p(t) can also be said to be a parameter related to the demand amount. The demand model λ can also be said to be a bivariate function of the timing t and the price p at the timing t.

Information about the demand model λ may be stored in a memory portion (not shown). Alternatively, information on the processing procedure representing the demand model λ may be stored in a memory portion (not shown). In this case, the seat reservation device 4 may determine the parameters in the demand model λ using training data as described below.

In the present example embodiment, the sales period is an example of the evaluation period described above in the first example embodiment. The price for reserving a seat on an airplane is an example of the first data described above in the first form. The quantity demanded is an example of the second data described above in the first example embodiment. In the demand model, the process of calculating gross sales, which is an example of the relation model described above in the first example embodiment, is an example of an evaluation model described above in the first example embodiment 1.

In the seat reservation device 4, the determination portion 13 determines the price by, for example, finding a solution to the problem where an objective function representing the gross sales (or the expected value of the gross sales) is maximized while satisfying the following constraint condition. Constraint condition: The total of the demand amount in the remaining period (i.e., the total of λ(t′, p) for each timing t′ in the remaining period) is less than or equal to the remaining amount n(t). In other words, no more seats can be reserved in the remaining period than the amount that remain at timing t.

In other words, the seat reservation device 4 calculates the solution to the problem of finding the price at which the expected value of gross sales increases while satisfying the above constraint condition. The solution may be the optimal solution where the objective function is maximized under the constraint condition, or it may be the output in the case of the condition for completing a given calculation being met in the process of finding a solution. Hereafter, for convenience, such problems will be denoted as “optimization problems” and the solutions to such problems will be denoted as “optimal solutions”. Mean, median, and other values are collectively denoted as “average”.

The process of finding an optimal solution to an optimization problem will be explained in detail, using the example of reserving a seat on an airplane. In order to increase the expected value of gross sales in cases where the price of seat reservations fluctuates during the sales period and the demand amount for seat reservations changes, it is desirable to set the price p(t) appropriately according to the timing t. The determination portion 13 finds the price p(t) in the case where the expected value of gross sales is the maximum. The determination portion 13 may find the price p(t) in the case where the expected value of gross sales increases. In other words, the determination portion 13 finds a solution to the optimization problem as described above with reference to the objective function. The following is a detailed description of the process of the seat reservation device 4.

Even if the demand model λ representing the relationship between the demand amount λ(t, p), the timing t, and the price p is unknown, the learning portion 17 uses the first data set (e.g., a data set associated with the price and the distribution of the demand amount relative to that price) to determine a demand model λ that calculates the demand amount λ(t, p) to match the first data set. In this case, the demand model λ represents the relation between price p and the demand amount (or mean, median, etc. of the demand amount) relative to the price p.

The evaluation portion 12 calculates the gross sales by executing the process shown in Expression (3), etc., using the first data set illustrated in Expression (1). The first data set (henceforth denoted “price set”) P for prices at timing t is, for example, the set shown in Expression (1).

$$[ Expression 1 ]$$

$$𝒫 = \{ {p}_{1} , ⋯ , {p}_{K} \} \qquad ( 1 )$$

However, K denotes the number of prices. For the sake of explanation, it shall be assumed that the first data set (e.g., the price set) is common for the timings described below with reference to Expression (2). However, for each timing, the number of elements in the first data set and the element value pᵢ (but 1≤i≤K) may vary. In other words, a price set may contain multiple prices for each timing.

The timing set T (henceforth denoted “timing set”) can be expressed as in Expression (2).

$$[ Expression 2 ]$$

$$𝒯 = \{ 1 , ⋯ , T \} \qquad ( 2 )$$

That is, a timing set contains multiple timings as elements. The timing set includes, for example, each timing in the period from the start timing to the end timing.

The learning portion 17 estimates the demand model λ using training data that includes the demand amount (or average of the demand amount) at each timing, the timing, and the set of prices at that timing. The demand amount may be actual data measured against price, or may be data calculated by a process that estimates the demand amount.

The learning portion 17 may calculate the demand model λ by, for example, determining the parameter of a curved surface (or curve, plane, or line) that fits the training data (hereafter denoted “regression analysis”). The parameter may be a single definite value or an ensemble of multiple values. Alternatively, the learning portion 17 may use a machine learning algorithm such as a neural network or support vector machine to calculate a demand model λ that fits the training data. Alternatively, learning portion 17 may determine the relationship between price and demand amount at each timing, rather than using the demand model explicitly. If there are multiple prices at each timing, the learning portion 17 may calculate the demand amount for each price.

Next, with reference to FIG. 5, the process in the seat reservation device 4 is explained. FIG. 5 is a flowchart showing the process flow in the seat reservation device 4 of the second example embodiment.

The calculation portion 11 acquires the demand model λ. The demand model λ may be given or created by the learning portion 17.

For the sake of explanation, the demand model λ is assumed to represent the relationship between the price p and the demand amount relative to the price p.

The calculation portion 11 calculates price p and the likelihood of the price p occurring. The calculation portion 11 may, for example, select a price p from the price set illustrated in Expression (1). The price p and the likelihood of price p occurring are updated so that the gross sales over the remaining period increases, as described below with reference to Expression (3).

The calculation portion 11 calculates the demand amount in the case of the price p at timing t using the price p at the timing t in the evaluation period and the demand model λ. As noted above, the evaluation period may be after the first period or may overlap with the first period. Alternatively, the evaluation period may be the same as the first period. In this case, it can be said that the calculation portion 11 calculates the demand amount in the evaluation period using the demand model λ in the first period. Alternatively, if the period between the start timing and the end timing occurs repeatedly, the first period and the evaluation period need only be two of the repeatedly occurring periods.

For example, suppose that the timing set in the evaluation period has timing 1 and timing 2. The evaluation period is, for example, the remaining period. Then, the calculation portion 11 determines, for each timing, the price and the likelihood of the price occurring, as shown below.
(1, p₁(1), x₁(1)), (1, p₂(1), x₂(1)), (2, p₁(2), x₁(2)), (2, p₂(2), x₂(2))

That is, there are two prices at timing 1: price p₁(1) and price p₂(1). Similarly, there are two prices at timing 2: price p₁(2) and price p₂(2). In this case, the price sets at the two timings are assumed to be identical.

The likelihood of the occurrence of price p₁(1) is x₁(1). The likelihood of occurrence of price p₂(1) is x₂(1). The likelihood of the occurrence of price p₁(2) is x₁(2). The likelihood of occurrence of price p₂(2) is x₂(2).

The evaluation portion 12 calculates the demand amount for each price using the demand model λ.

For example, the evaluation portion 12 calculates the demand amount λ(1, p₁(1)) for price p₁(1) using the demand model λ. The evaluation portion 12 calculates the demand amount λ(1, p₂(1)) for the price p₂(1) using the demand model λ. The evaluation portion 12 calculates the demand amount λ(2, p₁(2)) for the price p₁(2) using the demand model λ. The evaluation portion 12 calculates the demand amount λ(2, p₂(2)) for the price p₂(2) using the demand model λ.

The evaluation portion 12, for example, follows the processing procedure illustrated in Expression (3) (hereafter referred to as the “compensation model”) to determine the expected value of the gross sales over the remaining period. In this case, the processing procedure for calculating the expected value of gross sales is an example of an evaluation model. The processing procedure illustrated in Expression (3) can also be said to be a processing procedure for determining the expected value of such gross sales over the remaining period.

$$[ Expression 3 ]$$

$${\sum }_{{t}^{′} = t}^{T} {\sum }_{k = 1}^{K} {p}_{k} λ ( {t}^{′} , {p}_{k} ) {x}_{k} ( {t}^{′} ) = {\sum }_{r = r}^{T} {𝔼}_{P ( t )} [ P ( {t}^{′} ) λ ( {t}^{′} , P ( {t}^{′} ) ) ] \qquad ( 3 )$$

Σ denotes the process of calculating the sum. In Expression (3), pₖ represents one element in the price set P illustrated in Expression (1). t′ represents one element in the timing set illustrated in Expression (2). A. (t′, pₖ) represents the demand amount using the demand model λ, in the case of the timing t′ and the price pₖ. xₖ(t) represents the likelihood of the k-th price pₖ occurring at time t.

In the process shown in Expression (3), “pₖλ(t′, pₖ)” represents the process of calculating the gross sales at timing t. Therefore, the left side of Expression (3) represents the expected value of such gross sales over the remaining period.

If E_{P(t)}[P(t′)λ(t′, P(t′)] represents the expected value of gross sales at timing t′ and price pₖ, then the process shown on the left side of Expression (3) can also be described as the process shown in the right side of Expression (3). Accordingly, in the above example, the evaluation portion 12 calculates the expected value of gross sales according to, for example, the following process.

$$[ Expression 4 ]$$

$${\sum }_{ij} {p}_{i} \times λ ( j , {p}_{i} ) \times {x}_{i} ( j ) \qquad ( 4 )$$

However, Σᵢⱼ represents the process of calculating the sum for i and j.

The determination portion 13 calculates the price in the case of an increase in sales amount and the likelihood of this price occurring, from among the data that satisfy the constraint condition pertaining to the total demand amount in the remaining period (see Expressions (4) through (6) below). In other words, under the constraint condition, the determination portion 13 calculates the expected value of gross sales according to the process shown in Expression (3), and determines the price at which the calculated expected value will increase and the likelihood of this price occurring.

As noted above, the constraint condition expresses the condition that no more seats can be reserved in the remaining period than there are remaining. That is, the constraint condition expresses the condition that the statistic (e.g., the average value) of the demand amount λ(t′, P(t′)) in the remaining period is less than or equal to the remaining amount n(t) at timing t′. The determination portion 13 can perform the process of calculating the expected value of the demand amount (in this example, the number of reserved seats) under the constraint condition according to the process shown in Expressions (4) through (6) below.

$$[ Expression 4 ]$$

$${\sum }_{{t}^{′} = t}^{T} {\sum }_{k = 1}^{K} λ ( {t}^{′} , {p}_{k} ) {x}_{k} ( {t}^{′} ) = {\sum }_{{t}^{′} = t}^{T} {𝔼}_{P ( {t}^{′} )} [ λ ( {t}^{′} , P ( {t}^{′} ) ) ] \leq n ( t ) \qquad ( 4 )$$

$$[ Expression 5 ]$$

$${\sum }_{k = 1}^{K} {x}_{k} ( {t}^{′} ) \leq 1 , \qquad ( 5 )$$

$$t \leq {t}^{′} \leq T$$

$$[ Expression 6 ]$$

$${x}_{k} ( {t}^{′} ) \geq 0 \qquad ( 6 )$$

The process shown on the left-hand side of Expression (4) can also be expressed as follows, for example.

Σ_iΣ_jλ(j,pᵢ)×xᵢ(j)

The evaluation portion 12 follows the process shown in Expression (3) to obtain the expected value of gross sales. Then, the determination portion 13 determines the price and the likelihood of the price occurring so that the expected value of the gross sales increases. For example, the determination portion 13 may determine the price and the likelihood of the price occurring in a case where the expected value of the gross sales is maximized.

The determination portion 13 may then output the calculated price to an external device such as, for example, the display device 3 or the control device 2. Alternatively, the determination portion 13 may output the information representing the price to an e-commerce system, network auction system, or other system. The system receives the information representing the price and presents the price represented by the received information.

Next, the process of updating the demand model λ that the demand amount follows shall be described.

Suppose that an e-commerce system, network auction system, or other system has a measuring device (sensor) that measures the demand amount according to price. In other words, the sensor is measuring the demand amount according to price. In this case, the sensor measures, for example, the demand amount with respect to the price at timing t, as calculated by the determination portion 13.

The update portion 15 obtains the demand amount d (t) measured by the sensor. In this case, the demand quantity d (t) represents the demand quantity relative to the price at timing t. The update portion 15 updates the demand model λ using the set (t, P(t), d(t)) at timing t.

For example, suppose that update portion 15 presents price p1 at timing t1 to the system and obtains the demand amount di for that price p1 from the sensor. The update portion 15 updates the average demand per price, for example, using the demand amount obtained. If multiple demand amounts are obtained for the price, the update portion 15 updates the average of the demand amount by calculating the average of the multiple demand amounts. This process can also be described as the update portion 15 updating the demand model λ to fit the demand amount using the demand obtained from the sensor.

According to the above process, the actual demand amount for a price is obtained and the demand model λ is updated according to the obtained demand amount, so it is possible to estimate the future appropriate data relationship for multiple data that mutually affect the fluctuations with respect to the demand estimation target over time.

In the above, the processing of the determination device 1 was explained with reference to an example of calculating the objective function and constraint condition without using the demand model λ. However, if the calculation portion 11 obtains the demand model λ, it may perform the same process as described above using the obtained demand model λ. In this case, the process of calculating the expected value of gross sales as illustrated in Expression (3) may be the process of executing the processes shown in Steps A and B below for each timing in the remaining period and calculating the sum of the calculated sales (i.e., a process of finding the gross sales).

(Step A) Apply the demand model λ to the timing in the remaining period and the price at that timing. In other words, calculate the demand amount for the price at that timing.

(Step B) The sales amount is obtained by multiplying the calculated demand amount by the price.

Alternatively, as described above, the learning portion 17 may determine the parameter in the process of calculating the demand model λ so as to fit the training data. In this case, the determination device 1 may use the obtained demand model λ to perform the same process as described above, referring to step A and step B.

Next, the effects related to the seat reservation device 4 for the second example embodiment of the present invention will be described.

According to the seat reservation device 4 of the second example embodiment, efficiencies such as control efficiency, cost performance, and the like can be increased.

The reason for this is the same as that explained in the first example embodiment. Furthermore, according to the seat reservation device 4 of the second example embodiment, it is possible to determine the price in a case where gross sales increase during the evaluation period. The reason for this is that the demand amount relative to price can be used to calculate gross sales for the evaluation period.

### Third Example Embodiment

Next, the third example embodiment of the invention, which is based on the first example embodiment described above, shall be described.

The example shown in the third example embodiment represents an example in which merchandise is delivered from a collection/distribution center that manages the procurement of merchandise to various business partners (e.g., retailers, convenience stores, sales agents, etc.) who sell the merchandise.

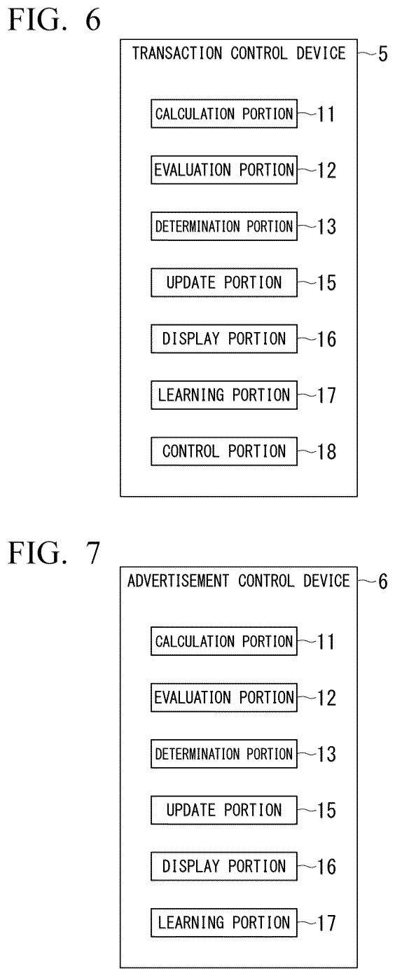

With reference to FIG. 6, the processing in the determination device 1 of the first example embodiment will be explained, using an example of application to the selection of a business partner. FIG. 6 is a block diagram showing the configuration possessed by a transaction control device 5 according to the third example embodiment of the present invention. The transaction control device 5 according to the third example embodiment has a calculation portion 11, an evaluation portion 12, a determination portion 13, and a control portion 18. The transaction control device 5 may have a learning portion 17 and an update portion 15.

The calculation portion 11 has the same functions as those possessed by the calculation portion 11 as described above with reference to FIG. 1. The evaluation portion 12 has the same functions as those possessed by the evaluation portion 12 as described above with reference to FIG. 1. The determination portion 13 has the same functions as those possessed by the determination portion 13 as described above with reference to FIG. 1. The learning portion 17 has the same functions as those possessed by the learning portion 17 as described above with reference to FIG. 1. The control portion 18 has the same functions as those possessed by the control device 2 as described above with reference to FIG. 1. The update portion 15 has the same functions as the update portion 15 has as described above with reference to FIG. 1. Therefore, the transaction control device 5 has functions similar to those possessed by determination device 1 as described above with reference to FIG. 1.

This section describes the evaluation model, etc. used in the explanation of the processing in the transaction control device 5 according to the third example embodiment. N denotes a business partner set that includes multiple business partners. If the business partners are N_{K} (K is a natural number), the business partner set N is expressed as follows.

$$N = \{ {N}_{1} , {N}_{2} , … , {N}_{K} \} \qquad ( 7 )$$

In the present example embodiment, the information representing the business partner is an example of the first data described above in the first example embodiment. The demand model λ represents the average of the demand amount in a case where the trading partners at timing t are N(t). The average of the demand amount is an example of the second data described above in the first example embodiment. The demand model 2 is an example of a relation model as described above in the first example embodiment.

The reward model represents the process of summing, for each timing t in the evaluation period, the rewards calculated according to the process described in Expression (8) for that evaluation period.

$$r ( t ) \times λ ( t , N ( t ) ) \qquad ( 8 )$$

However, r(t) represents the reward at timing t. In this example, for simplicity, r(t) is assumed to be constant, independent of the business partner. In the present example embodiment, the reward model is an example of the evaluation model in the first example embodiment.

The constraint condition is the condition that the total demand amount in the evaluation period must be less than or equal to the amount of merchandise in stock at the collection/distribution center. Therefore, the transaction control device 5 determines the business partner for the evaluation period by executing a process similar to that described above with reference to FIG. 2 or FIG. 3. The transaction control device 5 may perform so as to transact with the determined business partner. This process will be explained in detail.

The calculation portion 11 calculates the demand amount from the business partner in the evaluation period on the basis of the demand model λ that represents the relationship between the business partner and the demand amount from the business partner.

The evaluation portion 12 calculates the evaluation value for the evaluation period using the compensation model including the demand amount as a parameter and the demand amount in the evaluation period.

The determination portion 13 determines the business partner in the evaluation period in the case of an increase in the calculated evaluation value. The control portion 18 then performs control to transact with the determined business partner.

Next, the effects related to the transaction control device 5 according to the third example embodiment of the present invention will be described.

According to the transaction control device 5 of the third example embodiment, efficiency such as control efficiency and cost performance can be increased. The reason for this is the same as that explained in the first example embodiment. Furthermore, according to the transaction control device 5 of the third example embodiment, it is possible to determine the business partner in the case of an increase in total demand amount in the evaluation period. The reason for this is that the total demand amount in the evaluation period can be calculated using the demand model λ, which represents the relationship between business partners and the demand amount by those business partners.

### Fourth Example Embodiment

Next, the fourth example embodiment of the invention, which is based on the first example embodiment described above, shall be described.

The example shown in the fourth example embodiment is, for example, an example of efficiently selecting advertisements that are easy to refer to (or easy to access or view on the website indicated by the advertisement) when displaying advertisements on the Internet.

With reference to FIG. 7, the processing in the determination device 1 according to the first example embodiment will be explained, using an example of application to the selection of advertisements. FIG. 7 is a block diagram showing the configuration possessed by an advertisement control device 6 according to the fourth example embodiment of the present invention. The advertisement control device 6 according to the fourth example embodiment has a calculation portion 11, an evaluation portion 12, a determination portion 13, and a display portion 16. The advertisement control device 6 may have a learning portion 17 and an update portion 15.

The calculation portion 11 has the same functions as those possessed by the calculation portion 11 as described above with reference to FIG. 1. The evaluation portion 12 has the same functions as those possessed by the evaluation portion 12 as described above with reference to FIG. 1. The determination portion 13 has the same functions as those possessed by the determination portion 13 as described above with reference to FIG. 1. The display portion 16 has the same functions as those possessed by the display device 3 as described above with reference to FIG. 1. The learning portion 17 has the same functions as those possessed by the learning portion 17 as described above with reference to FIG. 1. The update portion 15 has the same functions as the update portion 15 has as described above with reference to FIG. 1. Therefore, the advertisement control device 6 has functions similar to those possessed by determination device 1 as described above with reference to FIG. 1.

This section describes the evaluation model, etc. used in the explanation of the processing in the advertisement control device 6 according to the fourth example embodiment. “Ad” represents an advertisement set containing multiple advertisements. If the advertisements are Ad_{K} (K is a natural number), then the advertisement set Ad is represented as follows.

$$Ad = \{ {Ad}_{1} , {Ad}_{2} , … , {Ad}_{K} \} \qquad ( 9 )$$

In the present example embodiment, information representing the advertisement is an example of the first data described above in the first example embodiment. The rate model λ represents the number of accesses in a case where the advertisement at timing t is Ad(t). In the present implementation, the number of accesses is an example of the second data described above in the first example embodiment. The rate model λ is an example of the relation model described above in the first example embodiment.

The evaluation model represents the process of summing, for each timing t in the evaluation period, the number of accesses λ(t, Ad(t)) for that evaluation period. The constraint condition is the condition that the total cost over the evaluation period be less than or equal to a given limit. Cost is, for example, the length of time an advertisement is displayed, the monetary cost of displaying the advertisement, etc. At timing t the cost of an advertisement being Ad(t) can be expressed, for example, as in Expression (10).

$$S ( Ad ( t ) ) \qquad ( 10 )$$

A given limit represents, for example, a maximum length of time during which an advertisement can be displayed, or a monetary cost upper limit to display an advertisement. Accordingly, the advertisement control device 6 determines the advertisement for the evaluation period by executing a process similar to that described above with reference to FIG. 2 or FIG. 3. The advertisement control device 6 may perform control so as to display the determined advertisement. This process will be explained in detail.

The calculation portion 11 calculates the percentage for the advertisement in the evaluation period based on the rate model λ, which represents the relationship between the advertisement and the percentage of the viewership of that advertisement.

The evaluation portion 12 calculates the evaluation value for the evaluation period using the evaluation model including the ratio as a parameter and the ratio in the evaluation period.

The determination portion 13 determines the advertisement in the evaluation period in the case of an increase in the calculated evaluation value.

The display portion 16 is then controlled to display the advertisement as determined.

Next, the effects related to the advertisement control device 6 according to the fourth example embodiment of the present invention will be described.

According to the advertisement control device 6 of the fourth example embodiment, efficiency such as control efficiency and cost performance can be increased. The reason for this is the same as that explained in the first example embodiment. Furthermore, according to the advertisement control device 6 of the fourth example embodiment, it is possible to determine the business partner in the case of an increase in total demand amount in the evaluation period. The reason for this is that the number of accesses during the evaluation period can be calculated using the rate model λ, which expresses the relationship between an advertisement and the number of accesses to the advertisement.

### Fifth Example Embodiment

Next, the fifth example embodiment of the invention, which is based on the first example embodiment described above, shall be described.

The example shown in the fifth example embodiment is an example of selecting a route to efficiently deliver an object such as merchandise to its destination. In this example, although the object is delivered to multiple designated points, the route of delivery of the merchandise to be delivered from one point to another varies according to timing.

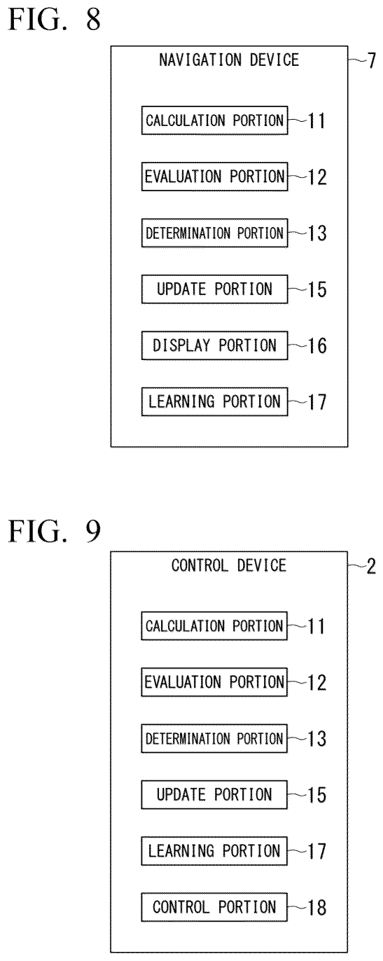

With reference to FIG. 8, the processing in the determination device 1 of the first example embodiment will be explained as it applies to the example described above. FIG. 8 is a block diagram showing the configuration of a navigation device 7 according to the fifth example embodiment of the present invention. The navigation device 7 of the fifth example embodiment has a calculation portion 11, an evaluation portion 12, a determination portion 13, and a display portion 16. The navigation device 7 may have a learning portion 17 and an update portion 15.

The calculation portion 11 has the same functions as those possessed by the calculation portion 11 as described above with reference to FIG. 1. The evaluation portion 12 has the same functions as those possessed by the evaluation portion 12 as described above with reference to FIG. 1. The determination portion 13 has the same functions as those possessed by the determination portion 13 as described above with reference to FIG. 1. The display portion 16 has the same functions as those possessed by the display device 3 as described above with reference to FIG. 1. The learning portion 17 has the same functions as those possessed by the learning portion 17 as described above with reference to FIG. 1. The update portion 15 has the same functions as the update portion 15 has as described above with reference to FIG. 1. Therefore, the navigation device 7 has functions similar to those possessed by the determination device 1 as described above with reference to FIG. 1.

This section describes the evaluation model, etc. used in the explanation of the processing in the advertisement control device 6 according to the fifth example embodiment. R represents a route set containing multiple routes. If the route is r_{K} (K is a natural number), the route set R is expressed as follows.

$$R = \{ {r}_{1} , {r}_{2} , … , {r}_{K} \} \qquad ( 11 )$$

In the present example embodiment, information representing the route is an example of the first data described above in the first example embodiment. A required time model λ represents the time required to deliver an object via route r at timing t to the next point. In the present example embodiment, information representing the required time is an example of the second data described above in the first example embodiment. The required time model λ is an example of a relation model as described above in the first example embodiment.

The evaluation model represents the process of summing, for each timing t in the evaluation period, the values calculated according to the process described in Expression (12) for that evaluation period.

$$G ( r ( t ) , t ) \times λ ( t , r ( t ) ) \qquad ( 12 )$$

G(r(t), t) represents the reward, etc. obtained in a case of delivering the object via route r(t) at timing t. The constraint condition is the condition that the total of the required time in the evaluation period be less than or equal to a predetermined time. Therefore, the navigation device 7 determines the route during the evaluation period by executing a process similar to that described above with reference to FIG. 2 or FIG. 3. The transaction control device 5 may perform control so as to display the determined route. This process will be explained in detail.

The calculation portion 11 calculates the travel time for a route in a case of traveling during the evaluation period based on the required time model λ that represents the relationship between the route and the travel time required to travel using that route. The evaluation portion 12 calculates the evaluation value for the evaluation period using the evaluation model including the travel time as a parameter and the travel time in the evaluation period.

The determination portion 13 determines the route in the evaluation period in the case of an increase in the calculated evaluation value.

The control portion 18 then controls the display of the determined route.

Next, the effects related to the navigation device 7 of the fifth example embodiment of the present invention will be described.

According to the navigation device 7 of the fifth example embodiment, the control efficiency, cost performance, etc. can be increased. The reason for this is the same as that explained in the first example embodiment. Furthermore, according to the navigation device of the fifth example embodiment, it is possible to determine the route in a case where the reward increases during the evaluation period. The reason for this is that the total demand in the evaluation period can be calculated using the required time model λ, which expresses the relationship between a route and the required time for that route.

### Sixth Example Embodiment

Next, the sixth example embodiment of the invention, which is based on the first example embodiment described above, shall be described.

The example shown in the sixth example embodiment is an example of control to efficiently acquire motive power in a system with multiple generators.

With reference to FIG. 9, the processing in the control device 1 of the sixth example embodiment will be explained as it applies to the example described above. FIG. 9 is a block diagram showing the configuration possessed by a control device 2 according to the sixth example embodiment of the present invention.

The control device 2 according to the sixth example embodiment has a calculation portion 11, an evaluation portion 12, a determination portion 13, and a control portion 18. The control device 2 may have a learning portion 17 and an update portion 15.

The calculation portion 11 has the same functions as those possessed by the calculation portion 11 as described above with reference to FIG. 1. The evaluation portion 12 has the same functions as those possessed by the evaluation portion 12 as described above with reference to FIG. 1. The determination portion 13 has the same functions as those possessed by the determination portion 13 as described above with reference to FIG. 1. The control portion 18 has the same functions as those possessed by the control device 2 as described above with reference to FIG. 1. The learning portion 17 has the same functions as those possessed by the learning portion 17 as described above with reference to FIG. 1. The update portion 15 has the same functions as the update portion 15 has as described above with reference to FIG. 1. Therefore, the control device 2 has functions similar to those possessed by determination device 1 as described above with reference to FIG. 1.

This section describes the evaluation model, etc. used in the explanation of the processing in the control device 2 according to the sixth example embodiment.

I represents a generator set that includes multiple generators. If the generator is I_{K} (K is a natural number), the route set I is expressed as follows.

$$I = \{ {I}_{1} , {I}_{2} , … , {I}_{K} \} \qquad ( 13 )$$

In the present example embodiment, information representing the generator is an example of the first data described above in the first example embodiment. The power model λ represents the electrical power consumption in a case where the generator I(t) is used at timing t. In the present example embodiment, information representing the electrical power consumption is an example of the second data described above in the first example embodiment. The electrical power model λ is an example of a relation model as described above in the first example embodiment.

The total motive power model represents the process of summing, for each timing t in the evaluation period, the conversion coefficients calculated according to the process described in Expression (14) for that evaluation period.

$$R ( I ( t ) ) \times λ ( t , I ( t ) ) \qquad ( 14 )$$

R(I(t)) represents the electrical power/motive power conversion factor for the generator I(t) at timing t. The total motive power model is an example of the evaluation model described above in the first example embodiment.

The constraint condition is the condition that the total electrical power consumption in the evaluation period is less than or equal to the total electrical power that can be consumed in that evaluation period (i.e., the upper limit of total electrical power consumption).

The total electrical power consumption in the evaluation period is calculated by summing the electrical power consumption λ(t, I(t)) for each timing in the evaluation period. Therefore, the control device 2 determines the business partner for the evaluation period by executing a process similar to that described above with reference to FIG. 2 or FIG. 3. The control device 2 may perform control so as to convert to motive power using a determined generator. This process will be explained in detail.

The electrical power consumed by the generator during the evaluation period is calculated based on an electrical power model that represents the relationship between the generator and the electrical power consumed by the generator.

The evaluation portion 12 calculates the evaluation value for the evaluation period using the motive power model representing the efficiency of converting electrical power consumption to motive power and the electrical power consumption in the evaluation period.

The determination portion 13 determines the generator in the evaluation period in a case where the calculated evaluation value increases.

The control portion 18 then performs control so as to convert to motive power using the determined generator.

Next, the effects related to the control device 2 according to the sixth example embodiment of the present invention will be described.

According to the control device 2 of the sixth example embodiment, efficiency such as control efficiency and cost performance can be increased. The reason for this is the same as that explained in the first example embodiment.

Moreover, according to the control device 2 of the sixth example embodiment, motive power can be efficiently obtained from the system. The reason for this is that the generator used during the evaluation period can be determined using a power model that represents the relationship between the generator and the electrical power consumption of that generator.

### (Hardware Configuration)

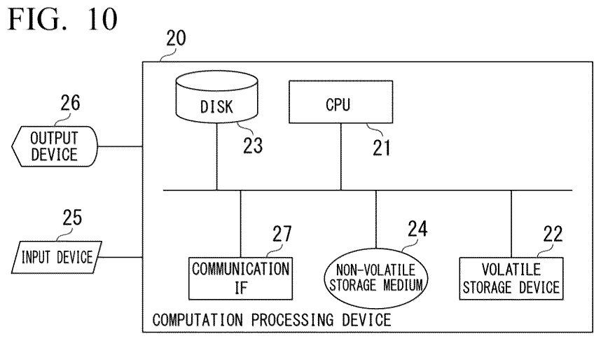

FIG. 10 is a block diagram outlining an example hardware configuration of a computational processor capable of realizing each of the determination device 1, control device 2, seat reservation device 4, transaction control device 5, advertisement control device 6, and navigation device 7 according to the example embodiments of the present invention.

This section describes an example of a hardware resource configuration that realizes the determination device 1, the control device 2, the seat reservation device 4, the transaction control device 5, the advertisement control device 6, and the navigation device 7 using a single computational processor (information processing device, computer). However, the determination device 1 may be physically or functionally realized using at least two computational processor. The determination device 1 may be realized as a dedicated device.

A computational processing device 20 has a central processing unit (hereinafter referred to as “CPU”) 21, a volatile storage device 22, a disk 23, a non-volatile storage medium 24, and a communication interface (hereinafter referred to as “communication IF”) 27. The computational processing device 20 may be connected to an input device 25 and an output device 26. The computational processing device 20 can send and receive information to and from other computational processors and communication devices via the communication IF 27.

The non-volatile storage medium 24 is a computer-readable medium, e.g., a Compact Disc, Digital Versatile Disc, or the like. The nonvolatile storage medium 24 may also be a Universal Serial Bus memory (USB memory), solid state drive, etc. The nonvolatile recording medium 24 retains the relevant program without power supply and thus allows it to be carried around. The nonvolatile recording medium 24 is not limited to the media described above. Instead of the non-volatile recording medium 24, the relevant program may be carried via the communication IF 27 and a communication network.

The volatile storage device 22 is readable by a computer and can temporarily store data. The volatile storage device 22 is a memory such as DRAM (dynamic random access memory), SRAM (static random access memory), and the like.

In other words, the CPU 21 copies the software program (computer program: hereinafter simply referred to as “program”) stored on the disk 23 to the volatile storage device 22 for execution, and executes the arithmetic operations. The CPU 21 reads the data necessary for program execution from the volatile memory device 22. If display is required, the CPU 21 displays the output results on the output device 26. In a case of entering a program from the outside, the CPU 21 reads the program from the input device 25. The CPU 21 interprets and executes the program (FIG. 2 or FIG. 3) in the volatile storage device 22 corresponding to the function (processing) represented by each part shown in FIG. 1, FIG. 4, FIG. 6, FIG. 7, FIG. 8, or FIG. 9. The CPU 21 executes the processes described in each of the abovementioned example embodiments of the invention. In other words, in such cases, each example embodiment of the present invention can be viewed as being made possible by the relevant program. Furthermore, each example embodiment of the present invention can also be achieved by a computer-readable, nonvolatile recording medium on which the relevant program is recorded.

The above-described example embodiments are exemplary examples to explain the invention. However, the present invention is not limited to the example embodiments described above. In other words, the present invention can be applied in various ways within the scope of the invention that can be understood by those skilled in the art.

Some or all of the above example embodiments may also be described as, but not limited to, the following Supplementary Notes.

### (Supplementary Note 1)

A determination device 1 comprising:
a calculation means that, based on a relation model representing a relationship between first data and second data, calculates second data in an evaluation period from first data in the evaluation period;
an evaluation means that calculates an evaluation value pertaining to the evaluation period by using an evaluation model and the calculated second data in the evaluation period, the evaluation model including the second data as a parameter; and a determination means that determines first data in the evaluation period in a case in which the calculated evaluation value increases.

### (Supplementary Note 2)

The determination device according to supplementary note 1, wherein the determination means determines the first data in the evaluation period in a case in which a constraint condition including the second data in the evaluation period as a parameter is satisfied and the evaluation value increases.

### (Supplementary Note 3)

The determination device according to supplementary note 1 or supplementary note 2, further comprising:
a creation means that, by using a data set in which the first data and the second data are associated, creates the relation model conforming to the data set,
wherein the calculation means calculates the second data in the evaluation period by using the created relation model.

### (Supplementary Note 4)

The determination device according to supplementary note 1 or supplementary note 2, further comprising:
a creation means that, by using a data set in which the first data and the second data are associated, creates the relation model conforming to the data set based on a distribution with respect to the second data,
wherein the calculation means calculates the second data in the evaluation period by using the created relation model.

### (Supplementary Note 5)

The determination device according to any of supplementary notes 1 to 4, further comprising:
an update means that acquires second data for the determined first data and updates the relation model by using the acquired second data,
wherein the calculation means calculates the second data in the evaluation period by using the updated relation model.

### (Supplementary Note 6)

The determination device according to any one of supplementary notes 1 to 5, wherein the relation model represents a relationship between the first data in a first period and the second data in the first period, and
the first period includes timings prior to each timing in the evaluation period.

### (Supplementary Note 7)

A determination method in which a computer execute: based on a relation model representing a relationship between first data and second data, calculating second data in an evaluation period from first data in the evaluation period; calculating an evaluation value pertaining to the evaluation period by using an evaluation model and the calculated second data in the evaluation period, the evaluation model including the second data as a parameter; and determining first data in the evaluation period in a case in which the calculated evaluation value increases.

### (Supplementary Note 8)

A recording medium that stores a program that causes a computer to realize function of: based on a relation model representing a relationship between first data and second data, calculating second data in an evaluation period from first data in the evaluation period: calculating an evaluation value pertaining to the evaluation period by using an evaluation model and the calculated second data in the evaluation period, the evaluation model including the second data as a parameter; and determining first data in the evaluation period in a case in which the calculated evaluation value increases.

### (Supplementary Note 9)

A seat reservation device comprising:
a calculation means that, based on a relationship between a price when reserving a seat and a demand amount for the price, calculates a demand amount in an evaluation period from a price in the evaluation period;
an evaluation means that calculates an evaluation value pertaining to the evaluation period by using an evaluation model, the price in the evaluation period, and the demand amount in the evaluation period, the evaluation model representing revenue in the evaluation period;
a determination means that determines a price in the evaluation period in a case in which the calculated evaluation value increases; and
a display means that displays the determined price.

### (Supplementary Note 10)

A transaction control device comprising:
a calculation means that, based on a relationship between a business partner and a demand amount from the business partner, calculates a demand amount from the business partner in an evaluation period;
an evaluation means that calculates an evaluation value for the evaluation period by using an evaluation model and the demand amount in the evaluation period, the evaluation model including the demand amount as a parameter;
a determination means that determines a business partner in the evaluation period in a case in which the calculated evaluation value increases; and
a control means that performs controls so as to transact with the determined business partner.

### (Supplementary Note 11)

An advertisement control device comprising:
a calculation means that, based on a relationship between an advertisement and the percentage of viewership of the advertisement, calculates the percentage for the advertisement in an evaluation period;
an evaluation means that calculates an evaluation value pertaining to the evaluation period by using an evaluation model that includes the percentage as a parameter and a percentage in the evaluation period;
a determination means that determines an advertisement in the evaluation period in a case in which the calculated evaluation value increases; and
a display means that displays the determined advertisement.

### (Supplementary Note 12)

A navigation device comprising:
a calculation means that, based on a relationship between a route and the travel time required to travel using the route, calculates travel time for the route when traveling in an evaluation period;
an evaluation means that calculates an evaluation value pertaining to the evaluation period by using an evaluation model and the travel time in the evaluation period, the evaluation model including the travel time as a parameter;
a determination means that determines a route in the evaluation period in a case in which the calculated evaluation value increases; and a display means that displays the determined route.

### (Supplementary Note 13)

A control device comprising:
a calculation means that calculates, based on a relationship between a generator and electrical power consumed by the generator, electrical power consumed by the generator in an evaluation period;
an evaluation means that calculates an evaluation value pertaining to the evaluation period by using an evaluation model and the electrical power consumption in the evaluation period, the evaluation model representing efficiency of converting electrical power consumption to motive power;
a determination means that determines a generator in the evaluation period in a case in which the calculated evaluation value increases; and
a control means that performs control of conversion to the motive power by using the determined generator.

### DESCRIPTION OF REFERENCE SYMBOLS

1 Determination device
2 Control device
3 Display device
4 Seat reservation device
5 Transaction control device
6 Advertisement control device
7 Navigation device
11 Calculation portion
12 Evaluation portion
13 Determination portion
14 Creation portion
15 Update portion
16 Display portion
17 Learning portion
18 Control portion

What is claimed is:

1. A determination device comprising:
a memory configured to store instructions; and
a processor configured to execute the instructions to:
based on a relation model representing a relationship between first data and second data, calculate second data in an evaluation period from first data in the evaluation period;
calculate an evaluation value pertaining to the evaluation period by using an evaluation model and the calculated second data in the evaluation period, the evaluation model including the second data as a parameter; and
determine first data in the evaluation period in a case in which the calculated evaluation value increases.

2. The determination device according to claim 1, wherein the processor is configured to execute the instructions to determine the first data in the evaluation period in a case in which a constraint condition including the second data in the evaluation period as a parameter is satisfied and the evaluation value increases.

3. The determination device according to claim 1,
wherein the processor is configured to execute the instructions to, by using a data set in which the first data and the second data are associated, create the relation model conforming to the data set, and
wherein the processor is configured to execute the instructions to calculate the second data in the evaluation period by using the created relation model.

4. The determination device according to claim 1,
wherein the processor is configured to execute the instructions to, by using a data set in which the first data and the second data are associated, create the relation model conforming to the data set based on a distribution with respect to the second data, and
wherein the processor is configured to execute the instructions to calculate the second data in the evaluation period by using the created relation model.

5. The determination device according to claim 1,
wherein the processor is configured to execute the instructions to acquire second data for the determined first data and update the relation model by using the acquired second data, and
wherein the processor is configured to execute the instructions to calculate the second data in the evaluation period by using the updated relation model.

6. The determination device according to claim 1,
wherein the relation model represents a relationship between the first data in a first period and the second data in the first period, and
the first period includes timings prior to each timing in the evaluation period.

7. A determination method executed by a computer, comprising:
based on a relation model representing a relationship between first data and second data, calculating second data in an evaluation period from first data in the evaluation period;
calculating an evaluation value pertaining to the evaluation period by using an evaluation model and the calculated second data in the evaluation period, the evaluation model including the second data as a parameter; and
determining first data in the evaluation period in a case in which the calculated evaluation value increases.

8. (canceled)

9. A seat reservation device comprising:
a memory configured to store instructions; and
a processor configured to execute the instructions to:
based on a relationship between a price when reserving a seat and a demand amount for the price, calculate a demand amount in an evaluation period from a price in the evaluation period;
calculate an evaluation value pertaining to the evaluation period by using an evaluation model, the price in the evaluation period, and the demand amount in the evaluation period, the evaluation model representing revenue in the evaluation period;
determine a price in the evaluation period in a case in which the calculated evaluation value increases; and
a display configured to display the determined price.

10.-13. (canceled)
